(19) United States
(12) Patent Application Publication
(10) Pub. No.: US 2015/0227382 A1
(43) Pub. Date: Aug. 13, 2015

(54) MONITORING VIRTUAL MACHINE PROTOCOLS, SERVICES, AND OPERATIONS

(71) Applicant: Red Hat Israel, Ltd., Ra'anana (IL)

(72) Inventor: David Botzer, Kfar Yona (IL)

(73) Assignee: Red Hat Israel, Ltd., Ra'anana (IL)

(21) Appl. No.: 14/178,285

(22) Filed: Feb. 12, 2014

(51) Int. Cl. G06F 9/455

(52) U.S. Cl. CPC G06F 9/45533

(57) ABSTRACT

Systems and methods for monitoring virtual machine protocols, services, and operations. An example method may comprise: initiating a connection to a virtual machine; receiving service data, the service data pertaining to one or more services installed on the virtual machine, and protocol data pertaining to one or more protocols utilized by the virtual machine; generating, with a processing device and in view of at least one of the service data or the protocol data, one or more configuration commands, the one or more configuration commands corresponding to at least one of the one or more services or the one or more protocols; and transmitting the one or more configuration commands to the virtual machine.

### TECHNICAL FIELD

The present disclosure is generally related to virtualized computer systems, and is more specifically related to systems and methods for monitoring virtual machine protocols, services, and operations.

### BACKGROUND

Virtualization may be viewed as abstraction of some physical components into logical objects in order to allow running various software modules, for example, multiple operating systems, concurrently and in isolation from other software modules, on one or more interconnected physical computer systems. Virtualization allows, for example, consolidating multiple physical servers into one physical server running multiple virtual machines in order to improve the hardware utilization rate. Virtualization may be achieved by running a software layer, often referred to as “hypervisor,” above the hardware and below the virtual machines. A hypervisor may run directly on the server hardware without an operating system beneath it or as an application running under a traditional operating system. A hypervisor may abstract the physical layer and present this abstraction to virtual machines to use, by providing interfaces between the underlying hardware and virtual devices of virtual machines. Processor virtualization may be implemented by the hypervisor scheduling time slots on one or more physical processors for a virtual machine, rather than a virtual machine actually having a dedicated physical processor. Memory virtualization may be implemented by employing a page table (PT) which is a memory structure translating virtual memory addresses to physical memory addresses.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level component diagram of an illustrative example computer system in accordance with one or more aspects of the present disclosure;

FIG. 2 depicts a flow diagram of an example method for monitoring virtual machine protocols, services, and operations, in accordance with one or more aspects of the present disclosure; and

FIG. 3 depicts a block diagram of an illustrative computer system operating in accordance with the examples of the present disclosure.

### DETAILED DESCRIPTION

In order for a user (e.g., an administrator) to identify/determine which protocols and/or services are running on a particular virtual machine (VM) (and/or the respective statuses of such protocols and/or services), existing technologies require that the user initiate a connection to the particular VM. In light of this limitation, existing technologies also do not enable the ongoing tracking/monitoring of statistics associated with such protocols/services.

Accordingly, described herein are methods and systems for monitoring virtual machine protocols, services, and operations. The described technologies can enable users (e.g., administrators) to externally monitor the various services and/or protocols that a particular VM is using (e.g., without initiating a connection to a particular VM), as well as the respective statuses of each service/protocol. Additionally, such technologies can enable the centralized monitoring of services, protocols, statuses thereof, etc., across multiple VMs. Moreover, the described technologies can enable the centralized configuration of such services and/or protocols. For example, as described herein, a centralized controller can be configured to monitor and log data pertaining to various services, protocols, and operations that may be utilized by one or more virtual machines. The referenced service, protocol, and/or operation data (including related statistics, statuses, etc.) can be collected and transmitted to the controller through an agent configured with respect to each virtual machine. In doing so, data pertaining to the respective services, protocols, and/or operations of several virtual machines can be centrally collected and maintained, thereby enabling a user (e.g., an administrator) to view and/or query such data without necessitating direct examination of/access to a particular virtual machine.

Additionally, the received service, protocol, and/or operation data (both data received in ‘real-time’ as well as historical data) can be analyzed (e.g., with respect to a specific virtual machine and/or several virtual machines), and various configuration commands (which can pertain to services, protocols, and/or operations of one or more virtual machines) can be generated and transmitted. In doing so, various configurations of such virtual machine(s) can be adjusted and/or modified in light of the received service, protocol, and/or operation data without necessitating direct access to a particular virtual machine.

Various aspects of the above referenced methods and systems are described in details herein below by way of examples, rather than by way of limitation.

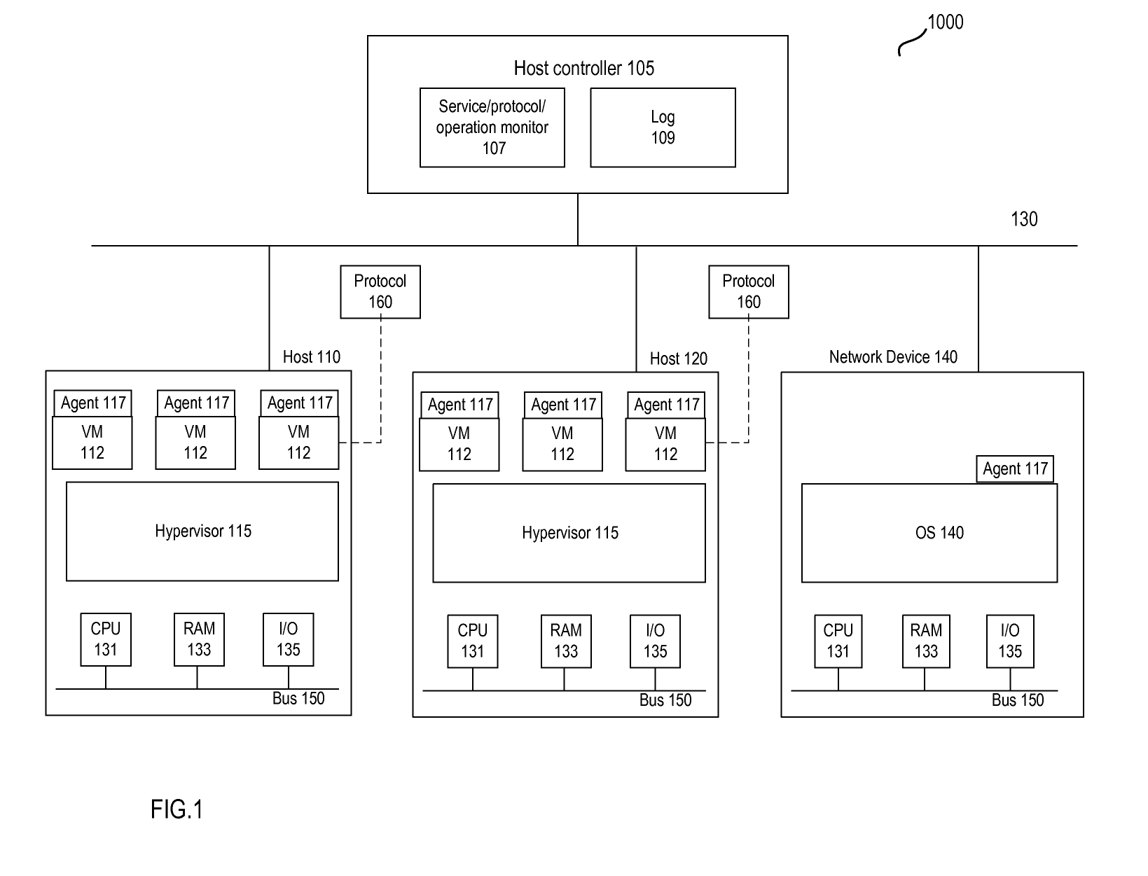

FIG. 1 depicts a high-level component diagram of one illustrative example of a computer system 1000 in accordance with one or more aspects of the present disclosure. The computer system 1000 may include computer systems 110, 120 (e.g., host computer systems), and 140 (e.g., a network device) interconnected via a network 130. Each of the host computer systems 110 and 120 and network device 140 may include one or more processors 131 communicatively coupled to memory devices 133 and input/output (I/O) devices 135. Local connections within each of the hosts 110 and 120, including the connections between processors 131, memory 133, and I/O devices 135 may be provided by one or more local buses 150 of suitable architecture.

“Processor” herein shall refer to a device capable of executing instructions encoding arithmetic, logical, or I/O operations. In one illustrative example, a processor may follow Von Neumann architectural model and may include an arithmetic logic unit (ALU), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU). “Memory device” herein shall refer to a volatile or non-volatile memory device, such as RAM, ROM, EEPROM, or any other device capable of storing data. “I/O device” herein shall refer to a device capable of providing an interface between one or more processor pins and an external device capable of inputting and/or outputting binary data.

Host computer systems 110 and 120 may run a plurality of virtual machines 112 on top of a hypervisor 115. Each hypervisor 115 may abstract the physical layer, including processors, memory, and I/O devices, and present this abstraction to virtual machines 112 as virtual devices, including virtual processors, virtual memory, and virtual I/O devices.

Virtual machine 112 may execute a guest operating system which may utilize the underlying virtual devices, including virtual processors, virtual memory, and virtual I/O devices. One or more applications may be running on virtual machine 112 under the guest operating system.

Network device 140 can be a device such as a router, switch, etc., which can connect various computer devices and/or networks to one another, route network traffic, etc., and which may communicate with hosts 110, 120 and/or virtual machines 112, such as via network 130 using one or more communication protocols.

In certain implementations, each virtual machine (as well as network device 140) can be configured with agent 117. Agent 117 can monitor various protocols, services and/or operations that pertain to the particular virtual machine (or device) to which it is configured. Data regarding the referenced protocols, services and/or operations can be requested by and/or provided to service/protocol/operation monitor 107 which can execute at host controller 105. For example, FIG. 1 depicts various virtual machines 112 that are connected to and/or otherwise utilizing protocols 160. Examples of such protocols include but are not limited to networking protocols such as HTTP, FTP, SSH, etc. Accordingly, agent 117 can monitor the utilization of such protocols by a particular virtual machine, as well as data/statistics associated with such protocols (e.g., bandwidth, etc.), and this information can be provided to service/protocol/operation monitor 107 on a periodic and/or ongoing basis. For example, one virtual machine may utilize the HTTP protocol (e.g., to communicate with another device, system, etc.), while another virtual machine may utilize an FTP protocol. In such a scenario, the protocols being utilized by the respective virtual machines can be monitored, as well as statistics pertaining to each protocol (e.g., the times/dates during which the protocols are utilized, traffic in/out, e.g., in megabytes, kilobytes, bytes, etc.), and such data can be presented/provided in real time and/or stored for historical analysis/reference. Moreover, as noted, agent 117 can monitor the utilization of various installed services (e.g., SSHD, NFS, etc.) by a particular virtual machine, as well as data/statistics associated with such services (e.g., the on/off status of such services, etc.), and this information can be provided to service/protocol/operation monitor 107. For example, one virtual machine may have an SSH service installed (e.g., SSHD), while another virtual machine have an FTP server service installed (e.g., vsftpd). In such a scenario, the services installed at the respective virtual machines can be monitored, as well as status/statistics pertaining to each service (e.g., whether a particular installed service is on/activated or off/deactivated, such as at a given time), and such data can be presented/provided in real time and/or stored for historical analysis/reference.

Additionally, in certain implementations, agent 117 can monitor one or more operations occurring in relation to a particular virtual machine as well as data/statistics associated with such operations. Examples of such operations include but are not limited to database operations (e.g., queries), storage operations (e.g., input/output), telephony operations, (e.g., phone calls), programming and provisioning operations, etc. As noted, this information can also be provided to service/protocol/operation monitor 107. For example, one virtual machine may perform one or more queries (e.g., with respect to an external database.), while another virtual machine may perform one or more storage operations (e.g., input, output, etc., such as with respect to an external storage device/server). In such a scenario, the operations being utilized/performed by the respective virtual machines can be monitored, as well as statistics pertaining to each operation (e.g., the times/dates during which the operations are performed, bandwidth associated with each operation, etc.), and such data can be presented/provided in real time and/or stored for historical analysis/reference.

It should be noted that while agent 117 is described in various examples herein as monitoring protocols, services and/or operations that pertain to a particular virtual machine, in certain implementations an agent 117 can be employed with respect to a physical host (e.g., a personal computer, server, network device 140, etc.), such as in order to monitor protocols, services and/or operations that pertain to such a device.

As schematically illustrated by FIG. 1, host computer systems 110 and 120 and network device 140 may be communicatively coupled to a host controller 105 which may reside on a designated computer system or on one of the hosts 110, 120. Host controller 105 may manage a plurality of virtual machines, including virtual machines 112. Host controller 105 may create a virtual machine, delete a virtual machine, and perform other virtual machine management functions. As noted, in certain implementations, host controller 105 may include a service/protocol/operation monitor 107 which may request and/or receive service, protocol, and/or operation data from one or more virtual machines 112 (or devices) via respective agents 117 configured thereto, in accordance with one or more aspects of the present disclosure.

As noted herein above, agent 117 can monitor various protocols, services and/or operations that pertain to the particular virtual machine 112. Data regarding the referenced protocols, services and/or operations can be requested by and/or provided to service/protocol/operation monitor 107 executing at host controller 105, and the received data can be stored in a database such as log 109. Based on the received protocol, service and/or operation data, service/protocol/operation monitor 107 can generate one or more configuration commands, which can, for example, include instructions that can modify or adjust various aspects of the functionality of a virtual machine 112 (e.g., to initiate, activate, start, stop, etc. a service at the virtual machine), and these commands can be transmitted to one or more virtual machines 112.

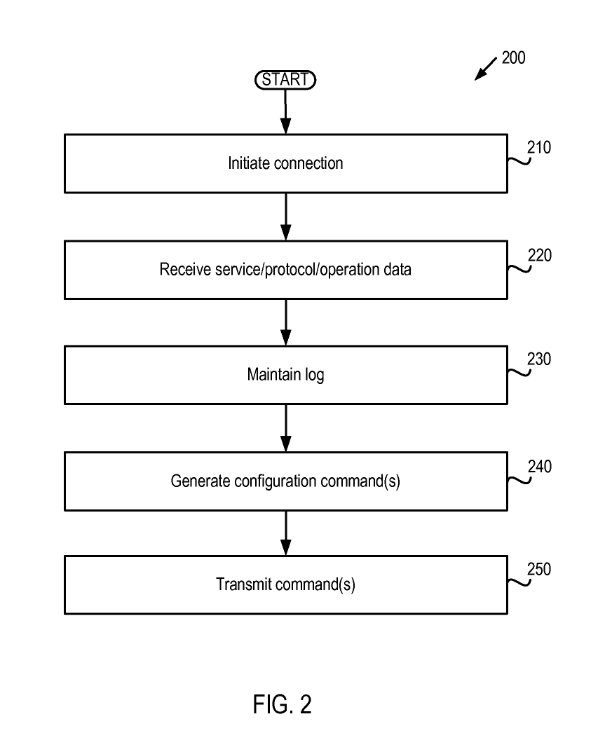

Example methods of monitoring virtual machine protocols, services, and operations in accordance with one or more aspects of the present disclosure are described herein below with reference to the flow diagram of FIG. 2.

FIG. 2 depicts a flow diagram of an illustrative example of a method 200 for monitoring virtual machine protocols, services, and operations. Method 200 and/or each of its individual functions, routines, subroutines, or operations may be performed by one or more processors of the computer system (e.g., host controller 105 of FIG. 1) executing the method. In certain implementations, method 200 may be performed by a single processing thread. Alternatively, method 200 may be performed by two or more processing threads, each thread executing one or more individual functions, routines, subroutines, or operations of the method. In an illustrative example, the processing threads implementing method 200 may be synchronized (e.g., using semaphores, critical sections, and/or other thread synchronization mechanisms). Alternatively, the processing threads implementing method 200 may be executed asynchronously with respect to each other.

At block 210, a connection to a virtual machine can be initiated, such as by host controller 105. Such a connection can be initiated via a local network or wide area network, such as the internet.

At block 220, service data can be received, such as by host controller 105. Such service data can pertain and/or otherwise relate to one or more services installed and/or executing on the virtual machine. Moreover, such service data can include information and/or statistics pertaining to such services (e.g., the status of such services, indicating, for example, that a particular service is/is not running). In certain implementations, protocol data can be received, such as by host controller 105. Such protocol data can pertain and/or otherwise relate to one or more protocols utilized by a virtual machine. Moreover, such protocol data can include information and/or statistics pertaining to such protocols (e.g., the bandwidth being used by a particular networking protocol). Additionally, in certain implementations, operation data can be received, such as by host controller 105. Such operation data can pertain and/or otherwise relate to one or more operations executing in relation to a virtual machine. Moreover, such operation data can include information and/or statistics pertaining to such operations (e.g., details concerning various aspects of the execution of the referenced operation).

It should be noted that service, protocol, and/or operation data can be received from agent 117 executing in conjunction with a virtual machine. In certain implementations, such service, protocol, and/or operation data can be provided by the agent on an ongoing and/or periodic basis. Moreover, in certain implementations such service, protocol, and/or operation data can be provided by the agent in response to a request/query originating at host controller 105.

At block 230, a log of the service, protocol, and/or operation data can be maintained, such as by host controller 105. Such a log can be maintained on an ongoing basis (e.g., in ‘real-time’ as data is received from an agent 117), while also maintaining historical data. In doing so, such data can be analyzed, such as with respect to a particular virtual machine and/or several virtual machines, such as described herein. Additionally, access to the data maintained at log 109 can be provided to various users (e.g., a system administrator), such as via a GUI and/or a web interface. Moreover, one or more database and/or reporting tools can be configured with log 109, in order to enable such users to run various database queries to and/or to generate various reports based on the service, protocol, and/or operation data.

At block 240, one or more configuration commands can be generated, such as by host controller 105. In certain implementations, such configuration commands can be generated based on the service, protocol, and/or operation data (such as the data received at block 220 and/or data previously received and stored in log 109). The configuration commands can correspond to one or more services, protocols, and/or operations. For example, based on service data received from a virtual machine that indicates that a particular service is or is not running, a configuration command can be generated to initiate, activate, start, stop, etc. such a service at the referenced virtual machine. By way of further example, based on protocol data received from a virtual machine that indicates that a particular protocol is utilizing a certain amount of bandwidth, a configuration command can be generated to initiate/activate a service (e.g., a data compression service) at the referenced virtual machine.

It should also be noted that, in certain implementations, configuration commands can be generated with respect to one virtual machine based on service, protocol, and/or operation data received from another virtual machine (or virtual machines). For example, based on protocol data received from one virtual machine that indicates that the virtual machine is utilizing a certain protocol, one or more configuration commands can be generated with respect to another virtual machine (e.g., to instruct the other virtual machine to stop utilizing the same protocols, to adjust the manner in which the other virtual machine uses the same protocols, to instruct the other virtual machine to utilize an alternative protocol, etc.).

At block 250, the one or more configuration commands can be transmitted, such as by host controller 105. In certain implementations, such configuration commands can be transmitted via a network to one or more virtual machines. Upon receiving such configuration commands, the virtual machine can execute the configuration commands.

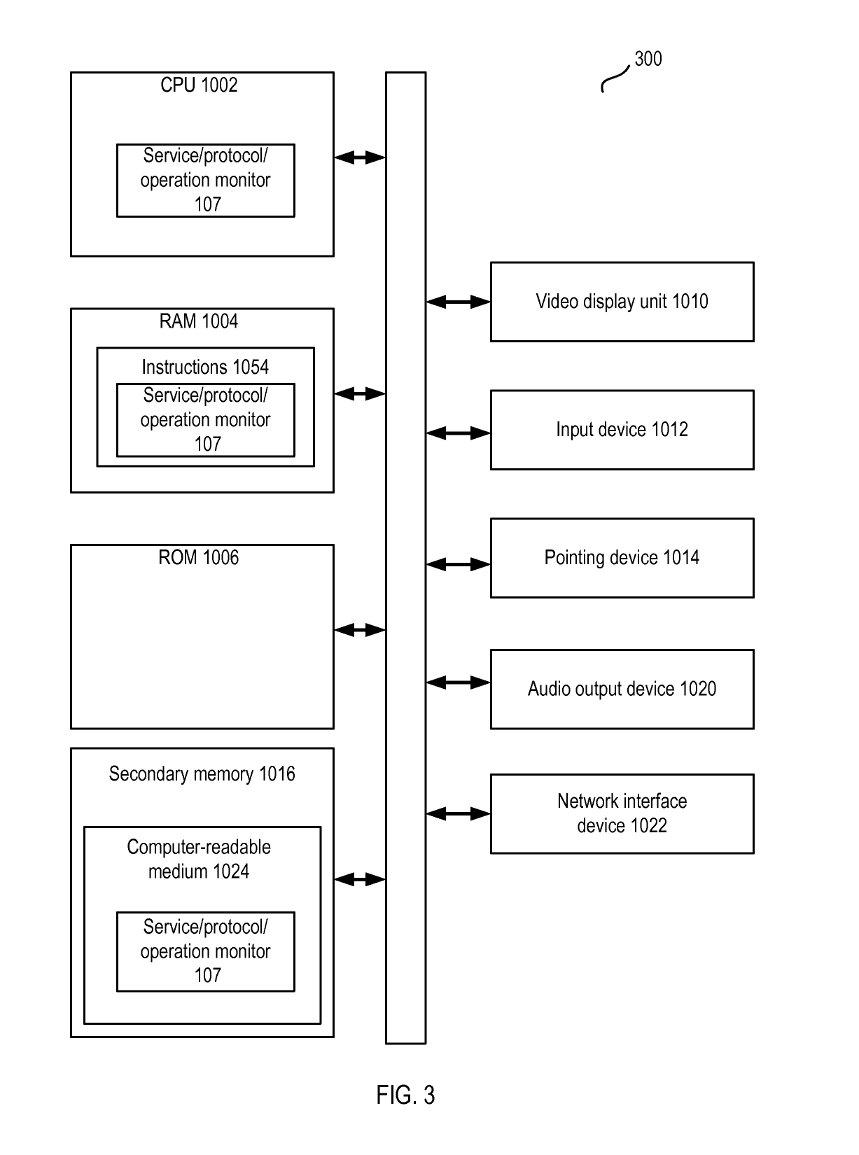

FIG. 3 depicts an example computer system 300 within which a set of instructions, for causing the computer system to perform any one or more of the methods described herein, may be executed. In certain implementations, computer system 300 may correspond to the host controller 105 of FIG. 1.

In an illustrative example, computer system 300 may be connected (e.g., via a network, such as a Local Area Network (LAN), an intranet, an extranet, or the Internet) to other computer systems. Computer system 300 may operate in the capacity of a server or a client computer in a client-server environment, or as a peer computer in a peer-to-peer or distributed network environment. Computer system 300 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 300 may include a physical processor 1002, a volatile memory 1004 (e.g., random access memory (RAM)), a non-volatile memory 1006 (e.g., read-only memory (ROM) or electrically-erasable programmable ROM (EEPROM)), and a secondary memory 1016 (e.g., a data storage device), which may communicate with each other via a bus 1008.

Processor 1002 may be provided by one or more physical processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 300 may further include a network interface device 1022. Computer system 300 also may include a video display unit 1010 (e.g., an LCD), an alphanumeric input device 1012 (e.g., a keyboard), a pointing device 1014 (e.g., a mouse), and an audio output device 1020 (e.g., a speaker).

Secondary memory 1016 may include a non-transitory computer-readable storage medium 1024 on which may be stored instructions of migration agent 107, 117 implementing the methods for monitoring virtual machine protocols, services, and operations described herein. Instructions of service/protocol/operation monitor 107 may also reside, completely or partially, within main memory 1004 and/or within processor 1002 during execution thereof by computer system 300, hence, main memory 1004 and processor 1002 may also constitute machine-readable storage media.

While computer-readable storage medium 1024 is shown in the illustrative example as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any non-transitory medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

Unless specifically stated otherwise, terms such as “initiating”, “receiving”, “generating”, “transmitting”, “maintaining”, or the like, refer to actions and processes performed or implemented by computer systems that manipulates and transforms data represented as physical (electronic) quantities within the computer system's registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for the required purposes, or it may comprise a general purpose computer system selectively programmed by a computer program stored in the computer system. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method operations. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

What is claimed is:

1. A method comprising:
initiating a connection to a virtual machine;
receiving service data, the service data pertaining to one or more services installed on the virtual machine, and protocol data pertaining to one or more protocols utilized by the virtual machine;
generating, with a processing device and in view of at least one of the service data or the protocol data, one or more configuration commands, the one or more configuration commands corresponding to at least one of the one or more services or the one or more protocols; and
transmitting the one or more configuration commands to the virtual machine.

2. The method of claim 1, wherein the virtual machine comprises a first virtual machine and wherein generating one or more configuration commands comprises generating, in view of at least one of the service data and the protocol data received from a second virtual machine, one or more configuration commands corresponding to at least one of the one or more services or the one or more protocols of the first virtual machine.

3. The method of claim 1, further comprising maintaining a log of the service data and the protocol data.

4. The method of claim 1, further comprising receiving operation data, the operation data pertaining to one or more operations executing in relation to the virtual machine.

5. The method of claim 4, wherein generating one or more configuration commands comprises generating, in view of the operation data, one or more configuration commands.

6. The method of claim 1, wherein transmitting the one or more configuration commands comprises transmitting one or more configuration commands to a plurality of virtual machines.

7. The method of claim 1, wherein the one or more configuration commands comprise a command to start or stop at least one of the one or more services.

8. The method of claim 1, wherein at least one of the service data or the protocol data are received from an agent executing in conjunction with the virtual machine.

9. A system comprising:
a memory; and
a processing device, coupled to the memory, to:
initiate a connection to a virtual machine;
receive service data that pertains to one or more services installed on the virtual machine, and protocol data that pertains to one or more protocols utilized by the virtual machine;
generate, in view of at least one of the service data or the protocol data, one or more configuration commands that correspond to at least one of the one or more services or the one or more protocols; and
transmit the one or more configuration commands to the virtual machine.

10. The system of claim 9, wherein the virtual machine comprises a first virtual machine and wherein to generate one or more configuration commands is to generate, in view of at least one of the service data and the protocol data received from a second virtual machine, one or more configuration commands that correspond to at least one of the one or more services or the one or more protocols of the first virtual machine.

11. The system of claim 9, wherein the processing device is further to maintain a log of the service data and the protocol data.

12. The system of claim 9, wherein the processing device is further to receive operation data that pertains to one or more operations that execute in relation to the virtual machine.

13. The system of claim 12, wherein to generate one or more configuration commands is to generate, in view of the operation data, one or more configuration commands.

14. The system of claim 9, wherein to transmit the one or more configuration commands is to transmit one or more configuration commands to a plurality of virtual machines.

15. The system of claim 9, wherein the one or more configuration commands comprise a command to start or stop at least one of the one or more services.

16. The system of claim 9, wherein at least one of the service data or the protocol data are received from an agent that executes in conjunction with the virtual machine.

17. A non-transitory computer-readable storage medium comprising executable instructions that, when executed by a processing device, cause the processing device to perform operations, comprising:
initiating a connection to a virtual machine;
receiving service data, the service data pertaining to one or more services installed on the virtual machine, and protocol data pertaining to one or more protocols utilized by the virtual machine;
generating, with the processing device and in view of at least one of the service data or the protocol data, one or more configuration commands, the one or more configuration commands corresponding to at least one of the one or more services or the one or more protocols; and
transmitting the one or more configuration commands to the virtual machine.

18. The non-transitory computer-readable storage medium of claim 17, wherein the virtual machine comprises a first virtual machine and wherein generating one or more configuration commands comprises generating, in view of at least one of the service data and the protocol data received from a second virtual machine, one or more configuration commands corresponding to at least one of the one or more services or the one or more protocols of the first virtual machine.

19. The non-transitory computer-readable storage medium of claim 17, wherein transmitting the one or more configuration commands comprises transmitting one or more configuration commands to a plurality of virtual machines.

20. The non-transitory computer-readable storage medium of claim 17, wherein at least one of the service data or the protocol data are received from an agent executing in conjunction with the virtual machine.
